(19) United States
(12) Patent Application Publication
(10) Pub. No.: US 2002/0124431 A1
(43) Pub. Date: Sep. 12, 2002

(54) Method for drying substances and/or preserving dryness by means of a semipermeable membrane

(76) Inventors: Patrick Duhaut, Franconville (FR); Isabelle Deschamps-Hulak, Montigny-Les-Cormeilles (FR); Eberhard Wittich, Gaillac (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/083,604

(22) Filed: Feb. 27, 2002

Related U.S. Application Data
(63) Continuation-in-part of application No. PCT/FR00/02389, filed on Aug. 28, 2000.
(63) Continuation-in-part of application No. PCT/FR00/02389, filed on Aug. 28, 2000.

(30) Foreign Application Priority Data
Aug. 27, 1999 (FR) 99/10849
Aug. 27, 1999 (FR) 99/10850

(51) Int. Cl. F26B 5/04

(52) U.S. Cl. 34/417

(57) ABSTRACT

The invention relates to a method for drying substances sensitive to being moisturized by a solvent, which mainly consists in separating said substances from a surrounding atmosphere in which said solvent is present, by hermetically sealing said substances in an envelope advantageously having a wall region which does not adhere to said substances and in which said envelope essentially consists of a polymer membrane which is selectively permeable to the vapor of the humidifying solvent but excludes said solvent in the liquid state. The method according to the invention can also be used to prevent dry products from being humidified.

This application is a continuation of International application number PCT/FR00/02389 (WO 01/16542) and a continuation of International application number PCT/FR00/02390 (WO 01/15893), both filed on Aug. 28, 2000 and both published under PCT article 21(2) in French language on Mar. 8, 2001, the entire disclosure of each of which is herein fully incorporated by reference. The corresponding French priority applications number 99/10849 (published FR 2,797,781) and 99/10850 (published FR 2,797,782) are also fully incorporated by reference herein.

The present invention relates to extractive separation techniques, which include, in particular, drying techniques consisting in bringing and/or keeping a product in a defined state of dryness, in terms of its content of a defined humidifying solvent. The invention is aimed particularly at providing pharmaceutical, chemical, cosmetic and agri-foodstuff industries with a novel membrane technique for solid/liquid or liquid/liquid separation as an alternative to the apparatuses already existing for concentrating products, for drying products and for keeping products dry.

To define and describe the invention in its preferred context, it will often be more useful, for the sake of clarity, to focus on the specific case of drying, that is to say on a method involving the extraction of a solvent responsible for a so-called wet state to be avoided. Among the least expensive and most conventional of industrial processes for drying products by stripping them of the water present, independently of any structural water, are vessels to which heat is supplied and/or a vacuum is applied, such as ovens, possibly stirred, and such as drum dryers or blade dryers. Other more expensive apparatuses, such as freeze drying systems which sublime the water or vacuum microwave systems, can also be used to dry products. In the case of products having a low melting point, apparatuses allowing them to be dried over a fluidized bed are generally used in industry.

However, all these apparatuses may be chronically overloaded, which means that products to be dried must remain for a certain amount of time outside the apparatuses, during which not insignificant amounts of solvent are emitted into the environment. In addition, these apparatuses often require many means of maintaining, cleaning and checking them. Yet the drying step, although this is the one which causes most problems in terms of feasibility, costs and delays compared with the operations which precede it, is essential at the end of manufacture of a product, as the dry form is the predominant form in which the product is transported and sold.

Furthermore, in order for the requirements of industry to be met most efficiently, the subject of the invention is a novel method of drying substances which are sensitive to being humidified or moisturised by a solvent, which has especially the advantages of being able to be used without the need for supplying energy, and especially fossil energy, and of being able to be used both in a laboratory and in industrial production sites.

This drying method is characterized in that it consists mainly in separating said substances from a surrounding atmosphere in which said solvent is present, by hermetically sealing said substances in an envelope advantageously having a wall region which does not adhere to said substances and in which said envelope essentially consists of a membrane made of a polymer material which is selectively permeable to the vapor of the solvent humidifying said substances to be removed in the presence of said solvent in the liquid state, as a result of a differential osmotic pressure between the two sides of said membrane, by migration of the gas molecules of said solvent within said polymer material, which migration is ensured due to the mobility of intramolecular vacant sites in the polymer material.

In practice, the method according to the invention therefore uses a semipermeable membrane which may be called integral as it is continuous, devoid of perforations and nonporous, which is nevertheless designed to let through individualized molecules, as the molecules in the gaseous state are, unlike the undifferentiated molecules of non-vaporized liquids. Such membranes are preferably of the type described in the international patent application filed on the same day as the present one, benefiting from the priority of the same date relating to French patent application 99/10850 in the names of the same inventors.

The method according to the invention therefore preferably involves, according to the content of that application, various secondary features which relate to the polymer composition used for forming the semipermeable membrane. In particular, the membrane, which is advantageously continuous and has neither perforations nor porosity, is preferably made of a copolymer formed from hard blocks providing said membrane with mechanical strength and from soft blocks, based on an elastomer oligomer, providing the membrane with selective permeability in the case of gas molecules of said solvent, due to the mobility of the vacant sites, and exhibiting preferential affinity for the molecules of said solvent.

When indicated above that the semipermeable membrane does not adhere to the substances to be dried, this does not at all mean that a wide space has to be maintained between their respective surfaces. In general, a sufficient natural space exists between substances in the solid state, as products in block or powder form, and the membrane, and even substances in the pasty or liquid state can be treated by the method of the invention.

The substances sensitive to being humidified or moisturised by a solvent concerned by the invention correspond either to substances containing a solvent which has to be removed in order to obtain dry and pure substances, or to substances which are already dry but which would easily pick up moisture if they are not separated from the surrounding atmosphere in which the solvent to which they are moisture-sensitive is present. It should be pointed out that the humidifying solvent is not necessarily aqueous in nature and that the moisture involved may be due to any solvent other than water.

The use of the drying method according to the invention is explained below in the case of wet substances, so called because they moisture from a solvent of which they must be stripped. This solvent is assumed to be water, even though the method applies without any substantial modification, and with the aid of the same membrane examples, to any solvent, even a non-aqueous but polar solvent. Indeed it is sufficient for such a solvent to benefit from that part of the polymer material of the same type of physicochemical affinity as the water vapor molecules. And such an affinity is achieved by polar bonds involving Van der Waals' forces, as is well known when dealing with hydrophilic compounds.

The drying method of the invention is based on a phenomenon similar to osmosis. It exploits the fact that an osmotic-type over-pressure is created inside the envelope containing the wet substances, said over-pressure being due to an increase in the partial pressure of the humidifying or moisturising solvent to be removed. Under such conditions, the laws of thermodynamics dictate that the vapor pressures on either side of the envelope wall equilibrate. According to the invention, and thanks to this pressure equilibrium between the internal environment and the external environment of the envelope, drying takes place progressively by evaporation of the solvent above the product to be dried inside the envelope and then by diffusion and transfer of the vapor of the humidifying solvent through the wall of the envelope. For products in the form of liquid solutions, drying by the hermetically sealed membrane means that partial evaporation of the solvent also takes place in the immediate vicinity of the internal face of the membrane in contact with said solvent and, since the solvent is present in large quantity, the overall drying rate is considerably improved.

It is clear that the gas molecules of the humidifying solvent diffuse by unidirectional migration through the thickness of the membrane, that is to say they migrate only from the inside of the membrane toward the outside, until thermodynamic equilibrium has been established. It is also clear that the evaporation of the solvent contained in the product held in the envelope assumes that said solvent to be removed from the product has a not insignificant saturated vapor pressure under the external temperature, pressure and relative humidity conditions.

As the solvent continues to evaporate and the gas molecules of said solvent diffuse through the envelope, the substance becomes depleted of liquid solvent and consequently it dries. The osmotic-type over-pressure remains inside the envelope as long as the substance is wet. Drying stops when thermodynamic equilibrium is achieved, namely when the partial pressures of the solvent to be removed on either side of the membrane become equal. From the thermodynamic standpoint, the activity of the solvent to be removed, defined as being equal to the ratio of the partial pressure of the solvent vapor in question above the product to be dried to the partial pressure of the vapor of the pure solvent at the same temperature, decreases with over-pressure and then remains constant once pressure equalization has been established.

From what was stated above, it is therefore apparent that the drying of the wet product hermetically sealed in the envelope is governed by two thermodynamic phenomena which combine their effects, namely, on the one hand, the evaporation of the solvent thus being extracted from the product to be dried, advantageously in the vicinity of a wall region away from the wet product, at least when it is in the solid state, and, on the other hand, the diffusion of the solvent vapor within the membrane, causing it to migrate through its thickness. On account of the phenomena involved, drying takes place whenever the rate of evaporation of the solvent in the envelope is more rapid than the rate of diffusion through the thickness of the membrane. However, it is desirable for the diffusion rate not to be too slow so that the drying is effective. It goes without saying that the gas molecules diffuse more rapidly the smaller the thickness of the membrane to be crossed. There ensues therefrom a way of controlling the rate of drying of a wet substance, by modifying the thickness of the membrane layer of the envelope.

As is also apparent from the aforementioned patent application, the semipermeable membrane used for drying is preferably transparent, or at least translucent, and transparency to visible radiation, or more generally to solar radiation, is particularly advantageous in most practical applications of the invention, in accordance with secondary features of the invention which mean that the wall having the semipermeable membrane is exposed on the outside to such radiation. In general from this standpoint, the invention stipulates that the drying takes place through a semipermeable membrane which, at least in its active part, is transparent to electromagnetic waves the wavelengths of which may preferably vary from 10 nm to 0.1 m, in other words radiation ranging from ultraviolet to microwaves.

This heats up the atmosphere containing the products to be dried, on the internal side of the membrane, due to the resulting confinement of the external radiation that has passed through it.

This is because, when the active membrane is hermetically sealed and exposed to a source of radiation, the temperature inside the container will increase owing to the occurrence of a radiation confinement phenomenon similar to that usually referred to as the greenhouse effect. The incident electromagnetic radiation loses some of its energy when passing through the membrane, so that the spectrum is modified thereby. On the inside to the film, there are found radiations that are capable of passing through the membrane in the reverse direction and are thence re-emitted to the outside, and other radiations that can only be reflected off the membrane and remains confined in the inside.

The radiation thus confined causes a significant rise in the temperature within the atmosphere sealed by the membrane. In addition, the membrane itself warms up. It is advantageous according to the invention to add, to the composition of the film, constituents capable of improving such a confinement effect during use of the film, by the addition of various molecules. Thus, according to a preferred embodiment of the membrane forming the subject of the invention, it is possible by incorporating in the polymer composition of the membrane silica particles of small size (for example of the order of a nanometer), in a proportion advantageously comprised between 2% and 20% by weight of the polymer composition, to afford a substantial increase of the temperature rise inside the membrane, as well as, consequently, of the rate of drying by gas diffusion through the membrane, due to the increase of the partial pressure of the solvent. (The silica is added to the polymer using the conventional methods known to those skilled in the art.)

In such conditions, the invention provides an inexpensive means of carrying out the drying, by exploiting the natural energy of solar radiation, which is readily available and non-polluting, to the exclusion of any energy, especially fossil energy. A complementary advantage of the radiation confinement effect is associated with the increase in the internal temperature of the membrane, insofar as this increases the mobility of the macromolecular chains and therefore the diffusion of the gas molecules through the membrane.

In all cases, the evaporation of the solvent and the migration of the solvent molecules in the vapor phase continue as long as the amount of solvent, by mass per unit volume, present in the atmosphere inside the membrane, above the product to be dried, remains greater than the amount of solvent material per unit volume outside the membrane, thus causing the thermodynamic re-equilibrium which makes the molecules migrate through the membrane. It will be clearly understood here that the higher the temperature inside the membrane, the more the solvent tends to vaporize above the product to be dried and therefore the more rapid is the migration of the molecules through the membrane.

Without wishing to limit the reality of the phenomena involved, the operation of the membrane and its selective permeability to vapors may be explained by an exclusive transfer of these vapors through the membrane directly due to the inherent structure of the macromolecular chains of the copolymerized material. This vapor transfer takes place by migration of the molecules throughout the thickness of the membrane according to one mode of operation which may be analyzed in greater detail as explained later.

Transfer by migration of the solvent gas molecules is made possible by the existence within the actual copolymerized material and on a microscopic scale of intramolecular spaces or vacant sites which overall constitute what is called the free volume. Indeed in a polymer material, the total volume occupied by the polymer comprises a first volume corresponding to the volume that the polymer would occupy if it were condensed and a second volume corresponding to the spaces not occupied by the polymer proper and which is known as the free volume.

According to the invention, the ability of the vacant sites to allow selective migration of the gas molecules through the thickness of the polymer material, to the exclusion of the same solvent in the liquid state, is exploited by making the polymer of the membrane so that, preferably by soft blocks, it exhibits selective chemical affinity with said gas molecules of the solvent, these molecules advantageously being small and thus able to migrate freely through the vacant sites in the polymer material.

To use the method according to the invention optimally therefore requires the semipermeable membrane to be able to establish physicochemical interactions with said molecules and to have a sufficient quantity of available free volume, the vacant sites being for this purpose large enough and mobile enough to receive the vapor molecules and drive them through the entire thickness of the membrane.

It should be pointed out that the size of the vacant sites is advantageously of the order of 1 angström (10⁻¹⁰ m), thereby making it possible for the dissociated molecules only to be transferred by migration through the thickness of the membrane, which is of the order of a few tens of micrometers in thickness. Since the liquid molecules are not individualized, they cannot pass through the membrane via the vacant sites.

In the preferred ways of implementing the invention, the polymer material is a copolymer formed from rather crystalline hard blocks, providing the material with mechanical strength, and rather amorphous soft elastomer blocks, providing the material with permeability to the solvent vapor by the mobility of the vacant sites. The chemical nature of the soft blocks is chosen so that said blocks exhibit selective affinity with regard to the solvent gas molecules, without any possibility of interaction with the other constituents of the material.

To produce a semipermeable membrane film suitable for containing substances to be dried by the method according to the invention, the polymer membrane may be combined with a mechanically reinforcing support layer, advantageously made integral therewith by adhesion, with or without the use of an adhesive in the form of an interlayer in the film thus formed. This support layer may especially be made of a textile fabric or the like, made especially from non-woven fibers, the nature of which is chosen so that it does not disturb the properties of the membrane. Such a non-woven fabric is, for example, based on fibers made of polypropylene resins or polyester resins.

The non-woven layer acts as a reinforcement or support layer, increasing the mechanical strength of the envelope, especially when it essentially comprises a mechanically very weak membrane because of the high mass proportion of soft blocks in it. It is not excluded to combine with the semipermeable active membrane several reinforcing layers, which flank it for example.

A similar support layer, based on a permeable felt of non-woven fibers, may be produced from other materials, such as paper. In particular, materials intended for the packaging of foodstuffs are chosen, these advantageously having a water permeability of between 50,000 and 100,000 g/m² per 24 hours and a grammage of between 26 g/m² and 100 g/m². They are sufficiently transparent to visible light to maintain the greenhouse effect increasing the drying rate.

Depending on the circumstances specific to each particular application, it may also be preferable to choose a polymer membrane which is thick and strong enough to represent the sole constituent of a monolayer film, in which case provision may be made to support the membrane, at the point of use, for example on a microperforated sheet. Of course, it is necessary each time to choose a support which does not impair the semipermeable properties of the membrane. To do this, it is advantageous for the material constituting the support layer to have an openwork structure. It is also necessary to ensure, before the membrane is fastened to the support layer, that the chemical composition of the material of said support layer is compatible with that of the membrane so that the adhesion between the membrane and the support layer is facilitated. A multilayer film suitable for implementing the drying method according to the invention is advantageously produced by hot calendering of the appropriate polymer, with the thickness of the membrane being controlled.

With regard to a membrane based on a copolymer formed from hard blocks and soft blocks, the respective proportion of each of the chain units in the polymer material determines the degree of permeability of the membrane. In light of what has been mentioned above with regard to the feasibility of gas molecule migration through the membrane, it will be understood that a polymer material intrinsically hydrophilic in nature, that is to say one in which the soft blocks are those of a hydrophilic oligomer and are in a functionally predominant proportion with respect to the hard blocks, essentially allows water vapor to be transferred. However, since hydrophilicity is a direct consequence of the presence of polar groups, said hydrophilic oligomer may also establish polar-type interactions with a polar organic solvent and consequently the method according to the invention makes it possible to dry products humidified by water or by any other polar organic solvent similar in behavior, such as methanol, ethanol and acetone which are frequently employed in organic synthesis.

In such conditions, it has been found that polymers of the poly(ether-block-amide) type are particularly suitable for implementing the method of drying according to the invention. A poly(ether-block-amide) is a block copolymer whose macromolecular chains consist of polyether blocks representing the soft blocks and polyamide blocks representing the hard blocks linked together in succession. Such a copolymer results from the polycondensation of polyamide oligomer chains having dicarboxylic chain ends with polyetherdiol oligomer chains. One particular poly(ether-block-amide) comprises a single type of polyamide block and a single type of polyether block. In particular within the context of the present invention, polyamide blocks exclusively formed from nylon-12 (—(CH₂)₁₁—CO—NH—), called PA-12, and polyetherdiol blocks formed either from polyethylene glycol (—O—(CH₂)₂—), denoted PEG, or from polytetramethylene glycol (—O—(CH₂)₄—), denoted PTMG, are used.

Focusing on the particular case in which the membrane is thus based on a poly(ether-block-amide), a non-limiting functional explanation of the selected permeability properties of the membrane with respect to water, an aqueous solvent or an organic solvent having a similar polar behavior is presented below.

The PA-12 blocks of the poly(ether-block-amide) are crystalline and rather hydrophobic. Intrinsically, they therefore tend to have a rather repulsive effect with regard to polar solvents. On the other hand, they afford mechanical properties necessary for the membrane to withstand certain industrial uses for which it is intended. In contrast, the polyether blocks are amorphous and rather hydrophilic. They therefore have, within the membrane selectively permeable to molecules in the gas phase, a selective affinity for molecules which, by polar attraction, lend themselves to specific physicochemical interactions with the macromolecular chains. It is therefore the polyether blocks, which, because of their affinity with the diffusing polar molecules, allow transfer of water vapor and vapor of polar solvents via the available vacant sites.

In the specific case of a poly(ether-block-amide), the ether functional groups of the polyether blocks provide the macromolecular chains of the membrane with additional rotations about the oxygen atom. This mobility of the chains provided by the oxygen atoms of the polyether blocks creates a larger amount of available free volume and therefore greater permeability of the membrane.

The number average molecular masses of the polyether blocks and of the PA-12 blocks are so selected that they are not too high in order to optimize the permeability capabilities of the membrane. Indeed, the amount of available free volume increases when the number-average molecular mass decreases. The number-average molecular mass of the PA-12 blocks is advantageously between 1,500 and 5,000 and that of the polyether blocks between 650 and 2,000.

The proportions of each of the polyamide and polyether blocks are chosen so as to obtain a material which is intrinsically hydrophilic in nature. Advantageously, the poly(ether-block-amide) used for implementing the method comprises from 30 to 60% by weight of polyether blocks and from 70 to 40% by weight of polyamide blocks.

More generally speaking, it may be stated here that, according to the invention, it is preferable for the polymer composition of the material of the membrane to comprise a major amount of softer oligomer blocks, characterized by the sites with hydrophilic affinity they include, and a minor amount of harder oligomer blocks with rather hydrophobic specific behavior.

It may be useful here to remind that the greater the amount of polyether blocks, the more rapid is the drying rate. Moreover, PTMG, because of its four CH₂ groups, is less polar than PEG, and consequently the rate of drying of a matter humidified by water or a polar solvent is slower when the polyether blocks of the poly(ether-block-amide) are based on PTMG. For products that have to retain a residual amount of solvent, it is therefore preferable to use PTMG as polyether blocks. However, this in no way limits the various ways of implementing the method forming the subject matter of the invention.

Although the membrane that has just been described by way of example is most particularly suitable for drying substances containing moisture from water or any polar solvent exhibiting similar behavior, it should be emphasized that it would not be outside the scope of the method of the invention if the substances were to contain a humidifying solvent of the non-polar kind. In this case it would be necessary, of course, to provide instead a membrane of the hydrophobic kind, for example a membrane consisting of polyolefins, so that it exhibits selected affinity with the gas molecules of said non-polar solvent.

Whatever the chemical composition of the membrane used for implementing the method according to the invention, said membrane is chosen to be continuous, that is to say it does not have any microperforations, and therefore it is impervious to bacteria and to microorganisms. Optionally, it is sterilized. The sterilization may be carried out by standard sterilization techniques such as by autoclaving (120° C.), by β or γ rays or by ethylene oxide. The use of a presterilized membrane allows the substances to be kept in a sterile environment. The membrane is, of course, chemically inert with respect to the solvent to be removed. Its properties also allow it to withstand heat for several hours, at least up to 80° C., optionally allowing the envelope containing the substances to be put into an oven, the heat supplied by the oven speeding up the drying operation. In this case, it is unnecessary to clean the ovens and check them out between two drying operations.

The thickness of the membrane is chosen so that the vapor does not migrate too slowly. In practice, it is greater than 2 μm, but less than 1,000 μm so as to be in the order of magnitude of a film generally flexible and able to be rolled up. Preferably, the actual thickness of the semipermeable membrane is between 10 and 100 μm, and advantageously between 10 and 60 μm.

Advantageously, the membranes used have a water vapor permeability of between 7,000 and 20,000 g/m²/24 h (according to the ASTM E 96 B standard at 38° C. and 50% RH), an oxygen permeability of 6,500 to 18,500 cm³/m²124 h/bar and a carbon dioxide permeability of between 72,000 and 177,000 cm³/m²/24 h/bar. Said membranes have a density of 1.02 to 1.07 g/cm³ and a Shore D hardness of 25 to 75. The elongation at break is about 365% and the breaking load close to 3.9 daN/mm².

According to an advantageous feature of the method of the invention, the product, once dry, does not pick up moisture if it is kept inside the hermetically sealed envelope. This is because, as we explained above, once thermodynamic equilibrium has been reached, no further vapor transfer can take place through the thickness of the polymer membrane. Since the latter is also impermeable to liquids, it is no longer possible for the product to pick up moisture. This consequently ensures that the product remains dry. If a product which is dry, but sensitive to moisture and in particular sensitive to moisture in the air, is placed in a hermetically sealed envelope consisting of a membrane having the features described above, said product remains dry. It is therefore clear that putting a product which is dry, but sensitive to humidification, in said envelope constitutes a treatment preserving its dryness.

Advantageously, the envelope containing the products to be dried is either in the form of a flat film, closing off a sealed system in standard storage or production sites, or in the form of hermetically sealed bags suitable in particular for drying products in the laboratory. The bags are hermetically sealed by means known per se, such as by heat sealing or ultrasonic sealing, or by adhesive means. In other cases, the envelope in the form of a flat film, which can be unrolled from rolls, is arranged as a “tunnel” covering plants outdoors. The substances to be dried may be placed in the tunnel on either an impermeable or permeable film forming the bottom of the enclosed space inside the membrane. They may also be laid on grids or in small cages for vegetables, which are themselves laid on said bottom film. The whole assembly is covered, with or without hoops, by means of the semipermeable membrane, optionally complexed with a support layer. Sufficient sealing along the edges of the membrane by pressing it into the soil is carried out.

In order to increase the rate and degree of drying, the wet substances to be dried may be laid on a grid, thereby making it possible to increase the active surface area of the membrane. For the same reasons, the product to be dried is advantageously in a divided state, in the form of small crystals or particles. For solid substances as products in block form having a size of greater than a few millimeters, it is advantageous to grind them up before packaging them in the envelope.

The method according to the invention is suitable for drying solid products, pasty or powdery products and liquid products. The pasty or powdery products particularly intended by the invention are pharmaceutical powders, specific solid chemicals, such as thixotropic products, and biological products of agricultural, animal or vegetable origin. As solid products that can be dried and kept dry by the method of the invention, mention may be made, for example, of mechanical and electronic articles, items used for obtaining a conviction in legal proceedings, and textiles such as clothing or household washing. With regard to products consisting of liquid solutions, the drying treatment results in an increase in the concentration of the solution, in the same way as products in which the wet product remains predominantly solid. Liquids such as blood, fruit juices, wine, milk or liquid waste, such as sewage farm waste, may be concentrated by means of the method of the invention.

According to a variant of the invention, the method is used not only for solid/liquid separation but for liquid/liquid separation. It is then a question of selectively separating off a liquid contained in a liquid mixture formed from at least two liquids differing in chemical nature. This separation is based on the same operating principle as in solid/liquid separation, namely evaporation of a liquid solvent followed by diffusion of the corresponding vapor through a membrane exhibiting selective affinity with regard to said solvent to be removed. One of the liquids of the mixture is compatible with the chemical composition of the membrane, and therefore especially is hydrophilic in nature in the case of the preferred example considered here, while the other is relatively incompatible with it, and therefore hydrophobic in nature under the same conditions. The membrane is selectively permeable to the vapor of the compatible solvent with which the membrane establishes chemical interactions facilitating migration of the vaporized molecules through the thickness of the membrane. The so-called incompatible solvent, which does not interact with the polymer of the membrane, is progressively stripped from the compatible solvent, and thus it becomes more concentrated until it becomes pure.

The very first advantage of the invention lies in the fact that the polymer membrane protects the product that it contains from attack from the external environment. In particular, it prevents the risk of cross contaminations occurring and prevents microorganisms from penetrating the envelope, thereby allowing very inexpensive aseptic drying.

Another advantage of the present invention lies in the fact that the quality of the drying of fragile products or of products difficult to dry is optimal. This is because, in the case of products sensitive to high temperatures, such as chemicals with a melting point below 40° C., and proteins or natural substances and extracts, the drying method avoids any denaturation.

Another advantage lies in the fact that the method according to the invention makes it possible to complete the drying of products which have been partially dried using another technique, by simply packaging the products in a hermetically sealed bag left at ambient temperature and pressure.

Another advantage lies in the fact that the products, even hygroscopic products, dried according to the method of the invention do not pick up moisture, at ambient temperature and pressure, when they are hermetically sealed in an envelope made of a substance intrinsically hydrophilic in nature.

Another advantage of the invention is that it eliminates the risk of toxicity for operators. This is because, since the products to be dried are put into a hermetically sealed envelope, operators are no longer in contact with toxic or potentially toxic products.

Finally, another advantage of the invention lies in the possibility of drying products cold in a closed chamber with air purification, avoiding pollution of the environment by the solvents as gaseous effluents discharged into the atmosphere.

The invention will now be described within the context of particular examples of implementation and application of the method.

### EXAMPLE 1

Hygroscopic granules containing 79% water were reduced to a powder by simple grinding. Next, 100 g of this powder were put into two separate envelopes, the total surface area of which was 962 cm². The envelopes used consisted of a semipermeable membrane formed from a polymer material based on a poly(ether-block-amide) composed of 40% by weight of PTMG blocks and 60% by weight of PA-12 blocks. The wall thickness of the envelope was 25 μm. Each envelope was heat sealed so as to obtain a bag. A flat container, containing the powder left open to the air, was used as a control.

The specimens in the bags were placed, on the one hand, on shelves at room temperature and, on the other hand, in an oven at 50° C.

The rate of drying of the control substance and of the granules placed in the envelopes at room temperature and at 50° C. were monitored over 70 hours. It was found that the weight of the control specimen hardly varied. In contrast, in the case of the products contained in each of the two envelopes, the weight loss was significant. The variation in weight loss as a function of time was substantially the same for each of the two envelopes, but the degree of drying was better when the envelope was put into the oven.

For each of the two envelopes, the weight of the product no longer varied much after 50 hours. After 70 hours, the weight of the product put into the envelope placed in the oven was 20 g, while that put into the envelope left at room temperature was 35 g.

### EXAMPLE 2

Scarcely ligneous plants were harvested in cool and rainy weather. 175 g of the plant specimen, which was coarsely cut up, were spread out in a hermetically sealed envelope. The total surface area of the envelope was 1,500 cm². The envelopes used consisted of a semipermeable membrane formed from a polymer based on a poly(ether-block-amide) composed of 40% by weight of PTMG blocks and 60% by weight of PA-12 blocks. The wall thickness of the envelope was 25 μm. A bag for freezing food was used as control.

The envelope and the freezing bag were suspended in a room without any mechanical ventilation. The temperature was maintained at around 19° C. and the relative humidity was 70%.

It was found that misting formed very rapidly on the internal surface of the control bag. Brown stains developed from the fourth day on the specimen, and invaded it thereafter. Fermentation odors were released when the bag was opened at the end of the test. The control bag was weighed regularly throughout the duration of the test and no weight variation was observed.

The specimen put into the envelope behaved differently. The plant retained its green color and an odor characteristic of a dry plant was given off during the test. When the envelope was opened, the plant crumbled in one's fingers.

The envelope was weighed regularly so as to measure the drying rate. The loss of moisture was appreciable as soon as the plant was put into the envelope. After the fourth day, the plant specimen weighed 90 g. After the sixth day, the weight loss was much less. By the tenth day, the specimen weighed no more than 55 g and was completely free of the moisture that it contained.

### EXAMPLE 3

A chemical substance having a melting point close to 40° C. and containing 20% water was put into a hermetically sealed envelope. The envelope consisted of a semipermeable membrane formed from a polymer material based on a poly(ether-block-amide) composed of 40% by weight of PTMG blocks and 60% by weight of PA-12 blocks. The wall thickness of the envelope was 25 μm and the total surface area of the envelope was 2,184 cm². The chemical underwent no physicochemical interactions with the poly(ether-block-amide). The product was also put into an open flat container, for comparing the drying effectiveness, in an oven at 40° C.

In such conditions, the product sublimed and the observed loss, at the end of drying, was 15% of the total mass.

In the case of drying the product placed in the envelope, the product sublimed inside the envelope, but its vapors did not pass through the wall because of the chemical incompatibility with the poly(ether-block-amide) of the product to be dried. Only water vapor molecules diffused through the wall. The calculated efficiency of this drying phase was close to 99.5%.

### EXAMPLE 4

Freshly cut medicinal plants placed directly on the soil were covered by a semipermeable membrane combined with a polyester non-woven forming a film. The membrane was based on a poly(ether-block-amide) consisting of 50% by weight of PA-12 blocks and 50% by weight of PEG blocks. The thickness of the active membrane was 18 μm. The grammage of the nonwoven was 30 g/m² and its thickness was 0.13 mm. The water vapor permeability of this film, measured using the method described in the ASTM E 96 B standard (at 38° C. and 50% RH), was 24,000 g/m per 24 hours.

Sealing along the sides and at the ends of the film with the earth was achieved so that the “tunnel” thus constructed in the open air was hermetically sealed. The plants thus covered dried in 48 hours without any energy being supplied, and especially without any consumption of fossil energy. The quality of the plants was similar to that of control specimens dried by hot air.

### EXAMPLE 5

Old garments were put into an envelope formed by a semipermeable membrane complexed to a flexible and microperforated polyethylene film having a grammage of 43 g/m². The semipermeable membrane was based on a poly(ether-block-amide) consisting of 50% by weight of PA-12 blocks and 50% by weight of PEG blocks and its thickness was 25 μm. The water vapor permeability of this complexed membrane measured using the method described in the ASTM E 96 B standard (38° C. and 50% RH), was 200 g/m per 24 hours.

The garments had to be maintained and kept with a moisture content of 45 to 55% in order to avoid the appearance of fungal growth if they were too wet or damage to the fibers if they were not wet enough.

Old clothes were also put into a simple polyethylene cover, having a water vapor permeability of 18 g/m² per 24 hours, in order to study the influence of the semipermeable membrane on the preservation of garments.

It was found that when the garments were protected by the complexed membrane, their appearance remained intact even if the external relative humidity was close to 100%, whereas, under the same conditions, the garments protected by the simple polyethylene cover picked up moisture and grew fungi, causing them to be progressively degraded.

Of course, and as already results from the foregoing, the invention is not limited to the conditions or to the magnitudes that have been specified in regard to the examples chosen to illustrate the invention in the preferred ways of implementing it.

1. A drying method for drying substances sensitive to being humidified by a solvent and/or keeping such substances in the dry state, wherein said substances are separated from a surrounding atmosphere in which said solvent is present, by hermetically sealing said substances in an envelope essentially consisting of a semipermeable membrane made of a polymer material which is selectively permeable to the vapor of the solvent humidifying said substances in the presence of said solvent in the liquid state, as a result of a differential osmotic pressure between the two sides of said membrane, by migration of the gas molecules of said solvent within said polymer material, which migration is due to the mobility of intramolecular vacant sites in the polymer material.

2. A drying method as claimed in claim 1, wherein said membrane is continuous, non-porous, and made of a copolymer formed from hard blocks providing said membrane with mechanical strength and from soft blocks, based on an elastomer oligomer, providing the membrane with selective permeability to gas molecules of said solvent, due to the mobility of the vacant sites, and exhibiting preferential affinity for the molecules of said solvent.

3. A drying method as claimed in claim 2, wherein said soft blocks have hydrophilic sites which provide said affinity with the gas molecules of said solvent by forming polar bonds and in that said soft blocks are functionally in a predominant proportion compared with the hard blocks, the copolymer being overall hydrophilic in nature so that the membrane is selectively permeable for water vapor or for the vapor of polar solvents exhibiting similar behavior.

4. A drying method as claimed in claim 1, wherein said membrane has, in its active regions, a thickness of 2 to 1,000 μm.

5. A drying method as claimed in claim 1, wherein the polymer membrane is fastened to a mechanically reinforcing support layer made of non-woven fibers.

6. A drying method as claimed in claim 1, wherein for substances that are in the solid state, said envelope has a wall region which does not adhere to said substances.

7. A drying method as claimed in claim 1, wherein said envelope is transparent, or at least translucent, to radiation to which it is exposed externally, the drying rate being improved thereby due to a greenhouse effect.

8. A drying method as claimed in claim 1, applied to the concentration of solutions in said solvent in the liquid state.

9. A drying method as claimed in claim 1, wherein the material constituting the polymer membrane is a copolymer of the poly(ether-block-amide) type having polyamide-based hard blocks and polyether-based soft blocks with hydrophilic sites, especially polyethylene glycol or polytetramethylene glycol.

10. A drying method as claimed in claim 7, wherein said substances to be dried are either covered with a flat film closing off a hermetically sealed system or are hermetically packaged in a bag, the film and the bag essentially being formed from the semipermeable polymer membrane complexed with at least one support layer.

11. A drying method as claimed in claim 4, wherein said membrane thickness is from 10 to 100 μm

12. A drying method as claimed in claim 1, wherein when said substances are in the solid state they are laid on a grid and/or presented in divided form.

13. A semipermeable membrane film for drying substances sensitive to being humidified by a solvent and/or keeping said substances in the dry state, comprising at least one reinforcing support layer providing mechanical strength to the complete film and a membrane layer adhering thereto which is continuous and nonporous, and thereby impervious to bacteria and microorganisms, and which consists of a polymer material formed from copolymerized crystalline hard blocks and elastomer soft blocks, said soft blocks being based on an oligomer having physicochemical affinity for said solvent and being present in a proportion with respect to said hard blocks which is efficient to ensure, via the mobility of intramolecular vacant sites in the copolymer, the migration of the gaseous solvent molecules through said membrane layer owing to the effect of an osmotic pressure difference occurring between its two sides, said membrane film being thereby selectively permeable to the vapor of a solvent in the presence of the corresponding liquid.

14. A film as claimed in claim 13, wherein said membrane is transparent or at least translucent, thus providing a possible radiation confinement effect, and wherein said copolymer material constituting said membrane layer further comprises elements capable of improving said confinement effect, thereby enhancing the drying of substances hermetically enveloped with said film.

15. A film as claimed in claim 14, wherein said elements are silica particles.

16. A film as claimed in claim 14, wherein said hard blocks of the copolymer material are formed from a polyamide such as nylon-12 and in that said soft blocks are formed from a polyetherdiol such as polyethylene glycol or polytetramethylene glycol.

17. A film as claimed in claim 14, wherein said support layer to which said membrane layer is complexed has an openwork structure so that it does not interfere with the selective permeability properties of the membrane.

18. A semipermeable membrane film for making envelopes for drying substances and/or maintaining such substances in a dry state when covered or enveloped therewith, comprising at least one reinforcing support layer providing mechanical strength to the complete film, said support layer being made of a textile fabric of non-woven fibers with openwork structure, and a membrane layer adhering thereto which is continuous and non-porous, and thereby impervious to bacteria and microorganisms, and which consists of a transparent or at least translucent polymer material made of a minor amount of crystalline harder oligomer blocks copolymerized with a major amount of elastomer softer blocks of an oligomer having hydrophilic affinity, said membrane film being thereby selectively permeable to the gaseous molecules of water or a similare polar solvent in the presence of the corresponding liquid, by migration of said gas molecules in said polymer material through said membrane via intramolecular vacant sites therein, wherein said polymer material constituting said membrane layer further comprises silica particles enhancing a radiation confinement effect for radiations to which the film is exposed in use.

19. A film as claimed in claim 18, wherein said membrane layer has a thickness from 10 and 100 μm,.

20. A film as claimed in claim 18, as a flexible flat film produced by hot calendering and able to be rolled up in the form of rolls from which it can be unrolled.
